(19) United States
(12) Patent Application Publication
(10) Pub. No.: US 2014/0180577 A1
(43) Pub. Date: Jun. 26, 2014

(54) METHOD AND SYSTEM FOR NAVIGATION AND ELECTRONIC DEVICE THEREOF

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-SAN CHIANG, New Taipei (TW); HAI-SHENG LI, Shenzhen (CN); MING-JIN LI, Shenzhen (CN); JUN WANG, Shenzhen (CN); XIAO-MAN PU, Shenzhen (CN); XIANG-KAI PAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/133,460

(22) Filed: Dec. 18, 2013

(30) Foreign Application Priority Data
Dec. 22, 2012 (CN) 2012105618251

(51) Int. Cl. G01C 21/00

(52) U.S. Cl. CPC G01C 21/00
USPC 701/468; 701/537

(57) ABSTRACT

A method for navigation is provided. The method includes the following steps. Generate a search request in response to manual operations and transmit the search request to a server. Receive a search result list including register users transmitted by the server. Select one or more register users in response to user selection operations. Generate a route inquire message and transmit the message to the server. Receive one or more replies, which transmitted by the electronic device of the selected register user and relayed by the server and display the one or more replies. An electronic device and a system for navigation are also provided.

### BACKGROUND

1. Technical Field

The present disclosure relates to an electronic device and a method and system for navigation for the electronic device.

2. Description of Related Art

Global Positioning System (GPS) is now used for route planning, automatic navigation and voice navigation. However, if the route environment of the destination is complicated or the electronic map has not been timely updated, the GPS navigation system will not work, and it is inconvenient for a user who is not familiar with the route environment of the destination.

Therefore, what is needed is an electronic device and a method and system for navigation for the electronic device thereof which can alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the views.

FIG. 1 illustrates an application environment of a system for navigation in accordance with an embodiment.

FIG. 2 is a block diagram of function modules of the system for navigation in accordance with the embodiment.

FIG. 3 is a block diagram of a server such as the one of FIG. 1, in accordance with the embodiment.

FIG. 4 is a block diagram of a first electronic device such as the one of FIG. 1, in accordance with the embodiment.

FIG. 5 is a block diagram of a second electronic device such as the one of FIG. 1, in accordance with the embodiment.

FIG. 6 is a flowchart of a method for registration before navigation, in accordance with an embodiment.

FIGS. 7A and 7B together constitute a single flowchart of a method for navigation, in accordance with an embodiment.

### DETAILED DESCRIPTION

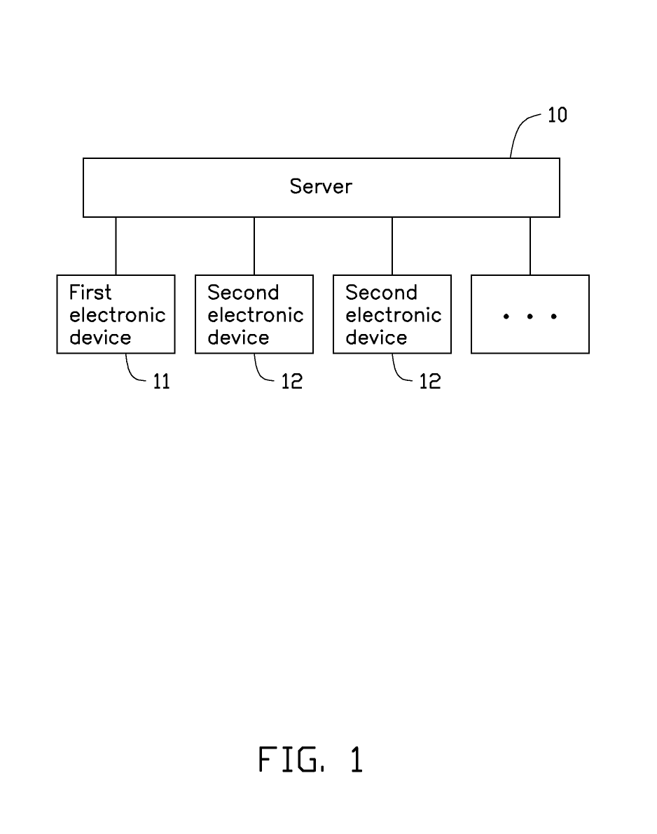

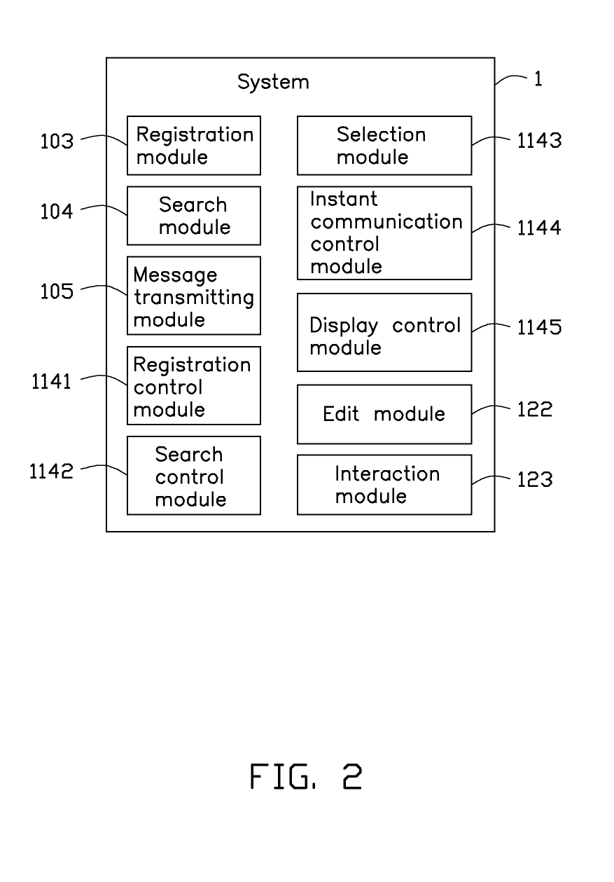

FIGS. 1 and 2 illustrate a system 1 for navigation. The system 1 has a number of function modules which are applied on a server 10 or a number of electronic devices with functions of navigation. The server 10 is a server of the GPS navigation system. The electronic devices include at least one first electronic device 11 and a number of second electronic devices 12. The first electronic device 11 and the second electronic devices 12 all communicate with the server 10. The first electronic device 11 is configured for creating a request for route inquire in response to user inputs. The second electronic devices 12 are configured for replying the request.

The function modules of the system 1 includes a registration module 103, a search module 104, a message transmitting module 105, a registration control module 1141, a search control module 1142, a selection module 1143, an instant communication control module 1144, a display control module 1145, an edit module 122 and an interaction module 123. The registration module 103, the search module 104, and the message transmitting module 105 are installed in the server 1 and run on the server 1. The registration control module 1141, the search control module 1142, the selection module 1143, the instant communication control module 1144 and the display control module 1145 are installed in a processor of the first electronic device 11. The edit module 122 and the interaction module 123 are installed in a processor of the second electronic device 12.

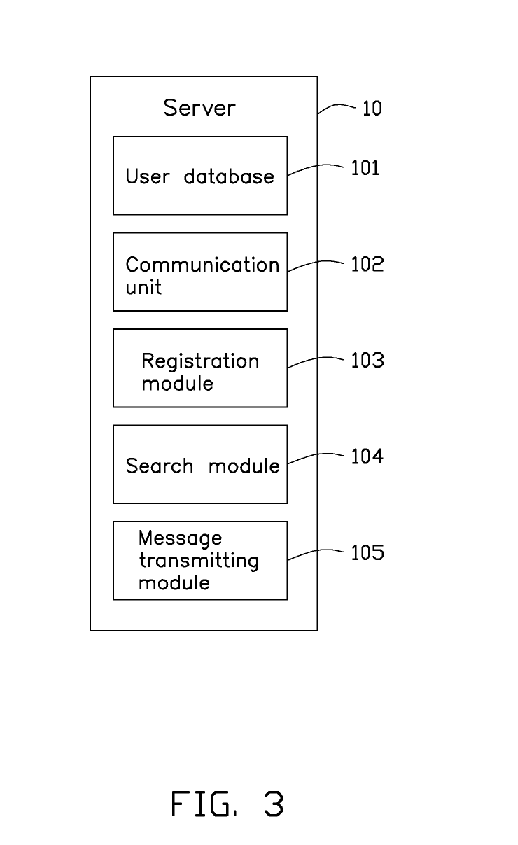

FIG. 3 shows that the server 10 includes a user database 101 and a communication unit 102. The user database 101 stores registration information of registered users. The communication unit 102 is configured for communicating with the first electronic devices 11 or the second electronic devices 12.

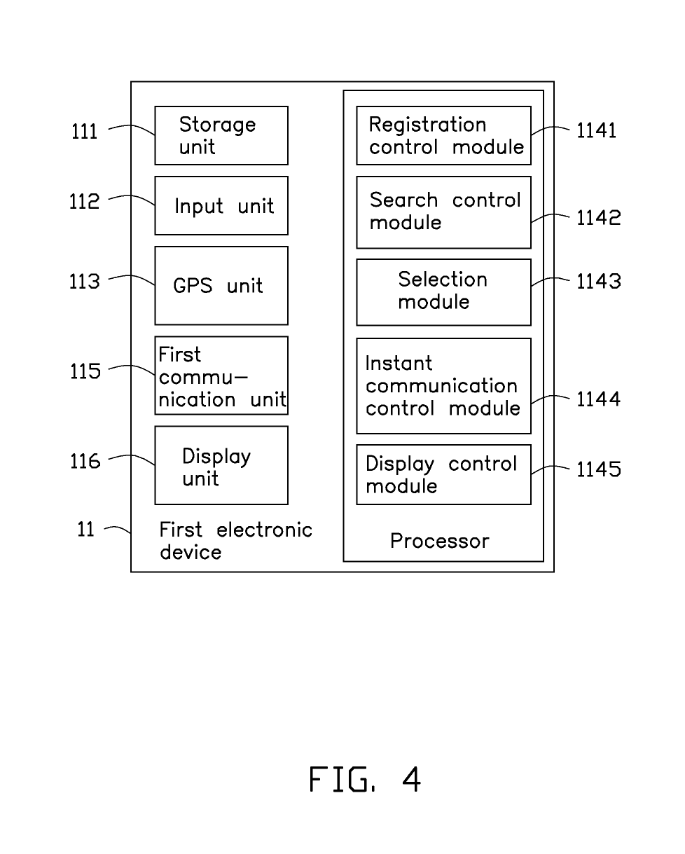

FIG. 4 shows that the first electronic device 11 includes a storage unit 111, an input unit 112, a GPS unit 113, the processor 114, a first communication unit 115 and a display unit 116. The storage unit 111, the input unit 112, the GPS unit 113, the first communication unit 115 and the display unit 116 are electrically connected to the processor 111 respectively.

The storage unit 111 stores an electronic map and at least one navigation applications. The electronic map is automatically updated when the navigation application is activated.

The input unit 112 is configured for generating corresponding input signals in response to applied operations. The input unit 112 is selected from the group consisting of: a touch screen, a keypad, a touchpad, a camera, or a microphone, for example.

The first communication unit 115 is configured for communicating with the server 10.

The GPS unit 113 is configured for receiving real-time navigation messages transmitted from the satellite of the GPS navigation system. The processor 114 is configured for determining the coordinates of the first electronic device 11 according to the received navigation message and controlling the first communication unit 115 to transmit the determined coordinates of the first electronic device 11 to the server 10.

The display unit 116 is configured for displaying information, such as the navigation map, the determined coordinates of the first electronic device 11 and so on.

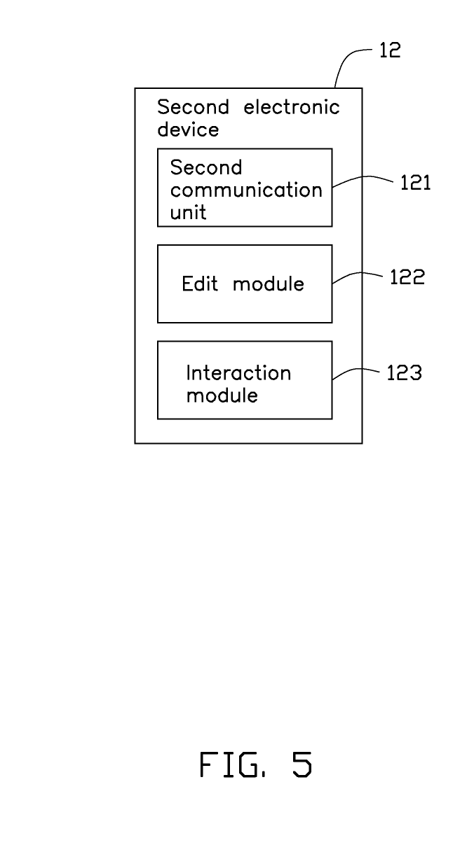

FIG. 5 shows that the second electronic device 12 includes a second communication unit 121. The second communication unit 121 is configured for communicating with the server 10.

The registration control module 1141 installed in the first electronic device 11 is configured for generating a register request in response to manual operations on the input unit 112 for a register on the server 10, and further configured for controlling the first communication unit 115 to transmit the register request to the server 10.

The registration module 103 is configured for controlling the communication unit 102 of the server 10 to receive the register request transmitted by and from the first electronic device 11, and recording a user according to the register request, and generating a register code and further controlling the communication unit 102 of the server to transmit the register code to the first electronic device 11.

The first communication unit 115 of the first electronic device 11 receives the register code and the storage unit 111 of the first electronic device 11 stores the register code.

The above described register request includes a number of information, such as personal information, if help was provided, the time period that help was provided, the residence, the familiar area, and the telephone number, for example. The registration module 103 is configured for controlling the storage of the above register information in the user database 101 of the server 10.

The search control module 1142 installed in the first electronic device 11 is configured for generating a search request including the determined coordinates using the first electronic device 11 in response to the manual operations applied on the input unit 112 by a user, and further configured for controlling the first communication unit 115 to transmit the search request to the server 10.

The search module 103 is configured for controlling the communication unit 102 of the server 10 to receive the search request transmitted by the first electronic device 11 and searching the database 101 of the server 10 according to the search request, and then generating a search result list which satisfies the search request and then controlling the communication unit 102 of the server 10 to transmit the search result list to the first electronic device 11. In addition, the search result list includes a plurality of registered users.

The first communication unit 115 of the first electronic device 11 receives the search result list and the storage unit 111 of the first electronic device 11 stores the search result list. The selection module 1143 installed in the first electronic device 11 is configured for selecting one or more registered users in the search result list in response to the manual selection operations applied on the input unit 112.

The instant communication control module 1144 installed in the first electronic device 11 is configured for generating a route inquire message containing register codes of the selected register users in response to the manual operations applied on the input unit 112, and further controlling the first communication unit 115 to transmit the route inquire message to the server 10. The above described route inquire message includes one or more register codes and the content of route inquire such as “I′m in Kunlun road, how can I get to Kunshan road”.

The communication unit 102 of the server 10 receives the message transmitted by the first electronic device 11. The message transmitting module 104 is configured for transmitting the message to one or more of the second electronic devices 12 which are associated with one or more register codes of the selected registered users.

The second communication unit 121 of the second electronic device 12 receives the message. The interaction module 123 is configured for analyzing the message. The edit module 122 is configured for editing a reply to the message in response to editing operations. The interaction module 123 is further configured for transmitting the reply to the server 10. The above described editing operations are selected from a group consisting of: operations of character inputting, operations of voice inputting, operations of inserting interception of map, etc.

The communication unit 102 of the server 10 receives the reply transmitted by the second electronic device 12. The message transmitting module 104 is further configured for controlling the communication unit 102 of the server 10 to transmit the reply to the first electronic devices 11. The above described reply includes a subject-matter including buildings and/or an exact road information such as “go straight and turn right at the first crossing”.

The first communication unit 115 of the first electronic device 11 receives the reply transmitted by the server 10. The display control module 1145 is configured for controlling the display unit 116 of the first electronic device 11 to display the reply.

The first electronic device 11 can navigate again according to the received reply. Furthermore, the user also can arrive at the destination according to the received reply without the help of the navigation of electronic device 11.

It is to be understood, in the embodiment, the first electronic device 11 and the second electronic device 12 both have functions of navigation, route inquire and reply to route inquire from others, and the first electronic device 11 and the second electronic device 12 both include corresponding functional modules. In an alternative embodiment, the second electronic device 12 has no functions of navigation and route inquire, and the second electronic device 12 has a function for reply to route inquire.

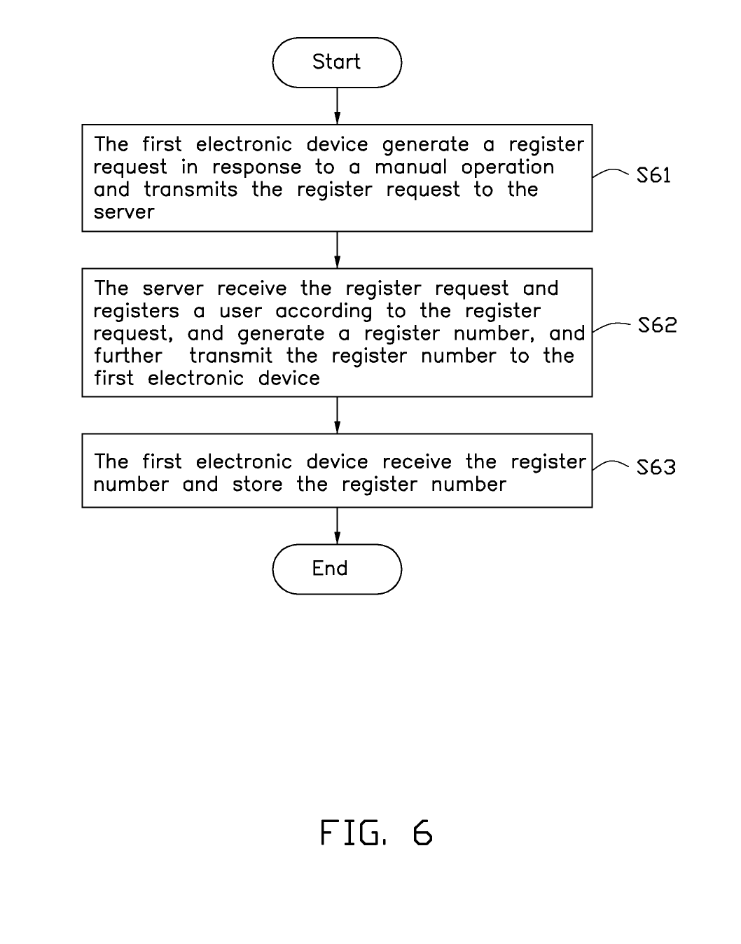

FIG. 6 shows a flowchart of a method for registration before a first time for navigating of the electronic device 11 of FIG. 1, in accordance with an embodiment. The first electronic device 11 includes an input unit 112. The input unit 112 is configured for generating input signals in response to the input operations applied thereon. The method typically includes the following steps, each of which is related to the various components contained in the server 10, the first electronic device 11 and the second electronic device 12.

In step S61, the registration control module 1141 generates a register request in response to the manual operations applied on the input unit 112 of the first electronic device 11 and controls the first communication unit 115 of the first electronic device 11 to transmit the register request to the server 10.

In step S62, the registration module 103 registers a user according to the register request, and generates a register code, and further controls the communication unit 102 of the server 10 to transmit the register code to the first electronic device 11.

In step S63, the first communication unit 115 of the first electronic device 11 receives the register code and stores the register code to the storage unit 111.

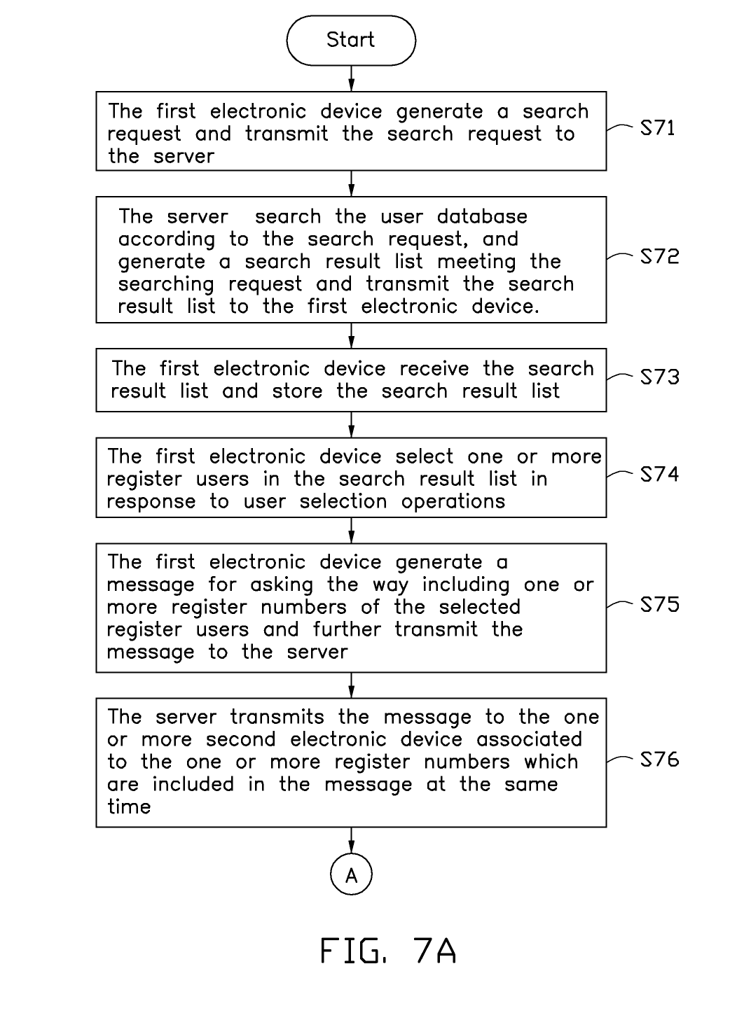

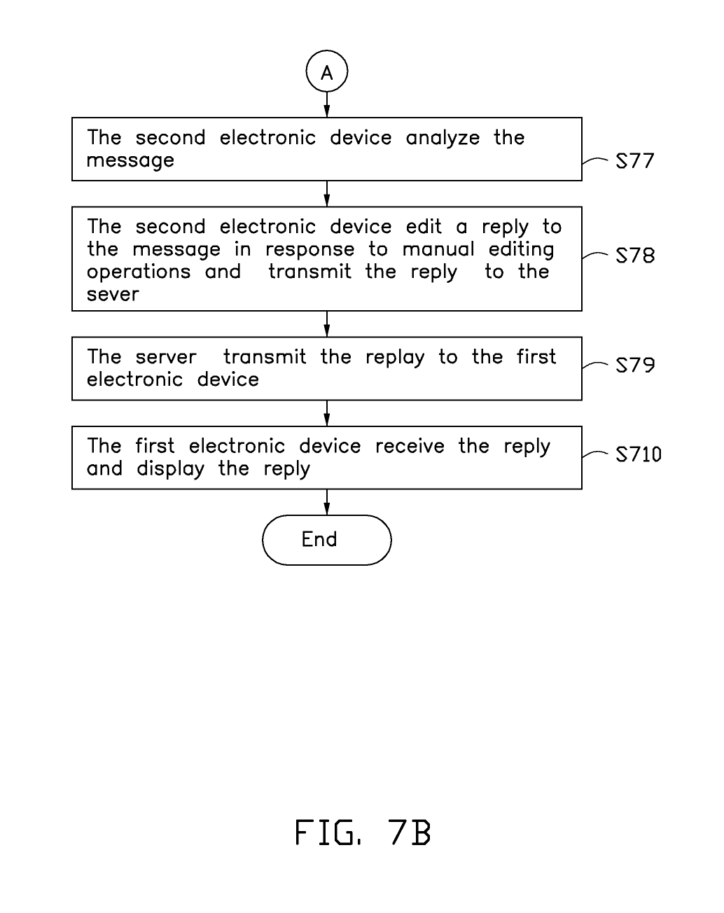

FIGS. 7A and 7B together constitute a single flowchart of a method for navigation for the electronic device 11 of FIG. 1, in accordance with the embodiment. The first electronic device 11 includes an input unit 112. The input unit 112 is configured for generating input signals in response to input operations applied thereon. The method typically includes the following steps, each of which is related to the various components contained in the server 10, the first electronic device 11, and one or more second electronic devices 12.

In step S71, the search control module 1142 generates a search request using the first electronic device in response to the manual operations applied on the input unit 112 of the first electronic device 11, and controls the communication unit 115 of the first electronic device 11 to transmit the search request to the server 10.

In step S72, the search module 103 searches the user database 101 according to the search request, and generates a search result list meeting the search request and further controls the communication unit 102 of the server 10 to transmit the search result list to the first electronic device 11.

In step S73, the first communication unit 115 of the first electronic device 11 receives the search result list and the storage unit 111 stores the search result list.

In step S74, the selection module 1143 selects one or more register users from the search result list in response to manual selection operations applied on the input unit 112 of the first electronic device 11.

In step S75, the instant communication control module 119 generates a route inquire message which includes one or more register codes of the selected register users and further controls the first communication unit 115 of the first electronic device 11 to transmit the message to the server 10.

In step S76, the message transmitting module 104 transmits the message to the one or more second electronic devices 12 associated to the one or more register codes which are included in the message at the same time.

In step S77, the interaction module 123 analyzes the message.

In step S78, the edit module 122 edits a reply to the message in response to manual editing operations and the interaction module 123 transmits the reply to the sever 10.

In step S79, the message transmitting module 104 transmits the reply to the first electronic device 11.

In step S710, the display control module 1145 controls the display unit 116 of the first electronic device 11 to display the reply.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for navigation for an electronic device, comprising:
generating a search request using the electronic device in response to a manual operation acted thereupon and transmitting the search request to a server;
receiving a search result list comprising a plurality of register users transmitted by and from the server;
selecting at least one register user from the search result list in response to selection operations;
generating a route inquire message containing register codes of the selected register users and transmitting the message to the server which further relays the message to electronic devices of the selected register user; and
receiving one or more replies transmitted by the electronic devices of the selected register users from the server and displaying the one or more replies.

2. The method as described in claim 1, further comprising:
receiving real-time navigation messages transmitted from the satellite of the GPS navigation system;
determining coordinates of the electronic device according to the received navigation messages; and transmitting the determined coordinates to the server.

3. The method as described in claim 2, wherein the search request comprises the determined coordinates of the first electronic device and a destination selected by the user.

4. The method as described in claim 1, wherein the method further comprises:
generating a register request in response to a manual operation and transmitting the register request to the server;
receiving a register code transmitted by the server and storing the register code.

5. An electronic device, comprising:
an input unit, configured for generating input signals in response to a manual operation applied thereon;
a display unit;
a communication unit;
a search control module, configured for generating a search request in response to an operation applied on the input unit, and further configured for controlling the communication unit to transmit the search request to a server and receive a search result list comprising a plurality of register users transmitted by the server;
a selection module, configured for selecting one or more registered users from the search result list in response to the selection operations applied on the input unit;
an instant communication control module, configured for generating a route enquire message which contains register codes of the selected register users, and further controlling the communication unit to transmit the message to the server and receive a reply to the message which transmitted by the electronic device of the selected register user and relayed by the server; and
a display control module, configured for controlling the display unit to display the reply.

6. The electronic device as described in claim 5, wherein the electronic device further comprises:
a GPS unit, configured for receiving real-time navigation messages transmitted by and from the satellite of the GPS navigation system;
a processor, configuring for determining coordinates of the electronic device according to the received navigation messages and controlling the communication unit to transmit the determined coordinates of the electronic device to the server.

7. The electronic device as described in claim 6, wherein the search request comprises the determined coordinates of the first electronic device and a destination selected by the user.

8. The electronic device as described in claim 7, wherein the electronic device further comprises:
a registration control module, configured for generating a register request in response to manual operations applied on the input unit, and further configured for controlling the first communication unit to transmit the register request to the server and receives the register code transmitted by the server and the storage unit is further configured for storing the register code.

9. A system for navigation, which is applied on a server and a plurality of first electronic devices and a plurality of second electronic devices; the server comprises a user database and a communication unit; the first electronic device comprises an input unit, a display unit and a first communication unit; the second electronic device comprises a second communication unit; wherein the system comprising:
a plurality of function modules executable on the first electronic device:
a search control module, configured for generating a search request using the first electronic device in response to an operation applied on the input unit by a user, and further configured for controlling the communication unit to transmit the search request to the server and receive a search result list comprising a plurality of register users transmitted by the server;
a selection module, configured for selecting one or more registered users from the search result list in response to manual selection operations applied on the input unit;
an instant communication control module, configured for generating a route enquire message which contains register codes of the selected register users, and further controlling the communication unit to transmit the message to the server and receive one or more replies which transmitted by the electronic device of the selected register user and relayed by the server; and
a display control module, configured for controlling the display unit to display the one or more replies;
a plurality of function modules executable on the server:
a search module, configured for searching the user database according to the search request, and generating the search result list which comprising a plurality of register users and meeting the search request and further configured for controlling the communication unit to transmit the search result list to the first electronic device;
a message transmitting module, configured for controlling the communication unit to transmit the message to the second electronic devices associated with plurality of selected register codes of the registered users and transmit the reply to the message to the one or more first electronic devices;
a plurality of function modules executable on the second electronic device:
an edit module, configured for editing the reply to the message in response to editing operations;
an interaction module, configured for transmitting the reply to the server.

10. The system as described in claim 9, wherein the search request comprises the determined coordinates of the first electronic device and a destination selected by the user.

11. The system as described in claim 10, wherein the system further comprises:
a registration control module executable on the first electronic device, configured for generating a register request in response to manual operations applied on the input unit, and further configured for controlling the first communication unit to transmit the register request to the server and receive the register code transmitted by the server and controlling the storage unit to store the register code.

12. The system as described in claim 9, wherein the interaction module is further configured for analyzing the received message.
